(19) United States
(12) Patent Application Publication
(10) Pub. No.: US 2003/0010368 A1
(43) Pub. Date: Jan. 16, 2003

(54) Pull handle for invalid walkers

(76) Inventor: John Dan MacKinnon, London (CA)

Correspondence Address: JOHN DAN MACKINNON, 1266 BRYDGES ST. APP. 7, LONDON, ON, N5W 2C3, CA

(21) Appl. No.: 10/084,805

(22) Filed: Feb. 28, 2002

Related U.S. Application Data
(60) Provisional application No. 60/240,649, filed on Oct. 10, 2000.

(51) Int. Cl. A61H 3/00

(52) U.S. Cl. 135/67

(57) ABSTRACT

The push and pull handle for walkers is a mechanical device consisting of a “U” shaped handle, a single “L” or “J” shaped handle or a club having an “S” type handle linked to a wheeled walker by one or two adjustable or folding anchor points. The device is used as a pull or push handle when attached to a geriatric walker often consisting of four wheels, two handles, brakes and a seat. The device enables a person to push or pull a person seated on the walker seat.

### TECHNICAL FIELD

Simply this device is mechanical in nature to aid loved ones or assistants in taking invalids on excursions

### BACKGROUND OF THE INVENTION

Invalid walkers have been designed so far except for a very few, with a seat facing backwards and it is with great difficulty if not completely impossible to keep an outing in motion with existing rear facing handles.

Walkers already take advantage of lightweightness portability and easy storage especially when compared to a wheelchair or a scooter and cost is also a consideration.

For most invalids fatigue or balance problems would make placing the seat on the front of the walker or over a forward-facing basket would be impractical. Hence according to this invention a forward facing handle on an inexpensive generic walker would be invaluable to the invalid and their caretakers

### SUMMARY OF THE INVENTION

A forward facing handle can help pull, push, turn in a circle if need be. It can be stored in an upright position and secured with a strip of hook and loop type fastener or other. It will not interfere with an unassisted walk nor will it add significant weight.

Friends and family or caretakers will fall in love with the new ability to assist when the invalid one is tired. This would be most noticeable and most appreciative during a long outing or when an appointment must be met, sometimes either can be mentally exhausting or taxing for either one.

As stated earlier merely moving the seat to the other side of the walker may exclude the need to have a handle at all but would increase the chance of a fall trying to turn the walker around or walking around it in order to sit.

Other features and objects of this invention will become apparent from the following description made with reference to the accompanying drawings, in which:

### BRIEF DESCRIPTION OF DRAWINGS

FIG. 1 is a perspective view of a “generic” type walker usually posessing a seat and two handles with brakes.

FIG. 1-a is a perspective view of a “generic” type walker usually posessing a seat and two handles with brakes.

FIG. 1-b is the embodiment of a “cane” type adjustable (or telescoping) handle attached to a “generic” type walker.

FIG. 1-c is a perspective view and a blow-up of a “generic” adjuster button from FIG. 1-e

FIG. 1-d is an endview of a “generic” adjuster button in the handle tubing of the blown up view from FIG. 1-c

FIG. 1-e is a perspective exploded view of a “cane” type adjustable (or telescoping) handle.

FIG. 1-f is a perspective drawing of a possible attachment clamp.

FIG. 1-g is a blown-up perspective view of FIG. 1-f

FIG. 1-h is a perspective view of a “U” type handle on a generics type walker.

FIG. 1-i is a perspective exploded view of a “fits-all” type extendable or expandable “U” type handle.

FIG. 1-j is a perspective view of the embodiment of a “T” type handle attached to a “generic” type walker.

FIG. 1-k is a perspective exploded view of a “T” type handle.

FIGS. 1-l is a perspective drawing of a possible attachment clamp.

FIG. 1-m is a perspective exploded view showing details of a possible attachment clamp.

FIG. 2 is a perspective view of the embodiment of a “U” shaped handle according to this invention.

FIG. 3 is a perspective view of a split-foam grip to be slid over the “U” shaped handle with a 110° bend as in FIG. 4.

FIG. 4 is a perspective rear view of the “U” shaped handle with a 110° bend showing its adjustable width capabilities.

FIG. 5 is a perspective view of a protective plastic end cap to be inserted in the end of the metal tubing of all models of pull handle.

FIG. 6 is a side view of the same protective (safety) end cap.

FIG. 7 is a bottom view of the same protective end cap.

FIG. 8 is a perspective view of the embodiment of a single or “L” type handle with a wagon type pull on its' end according to this invention.

FIG. 9 is a top view of a common hose clamp.

FIG. 10 is a perspective view of the embodiment of a “T” type pull (as an alternative pull) according to this invention.

FIG. 11 is a top view of the embodiment of a swivel mount for a single or “L” type handle according to this invention.

FIG. 12 is a side view of the same swivel mount.

FIG. 13 is a common lock nut with nylon insert.

FIG. 14 is a common machine screw of the same thread and pitch; approx. 5 cm. long (2 inches).

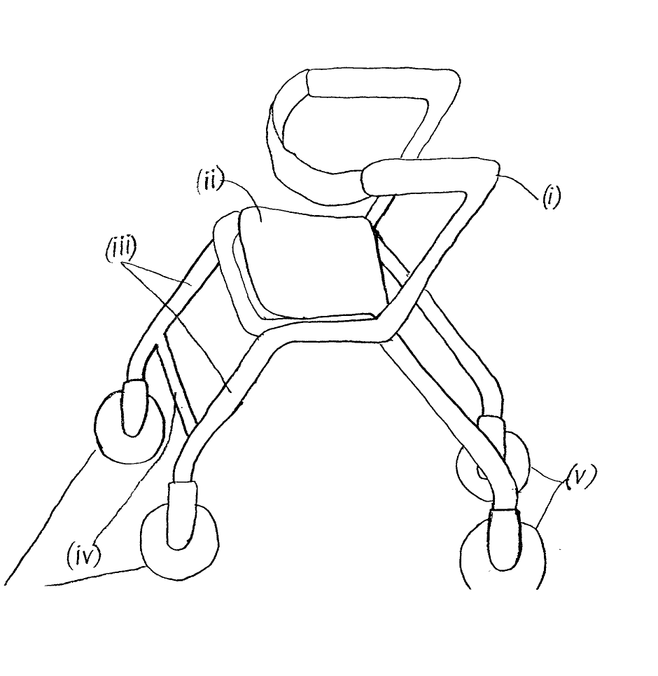

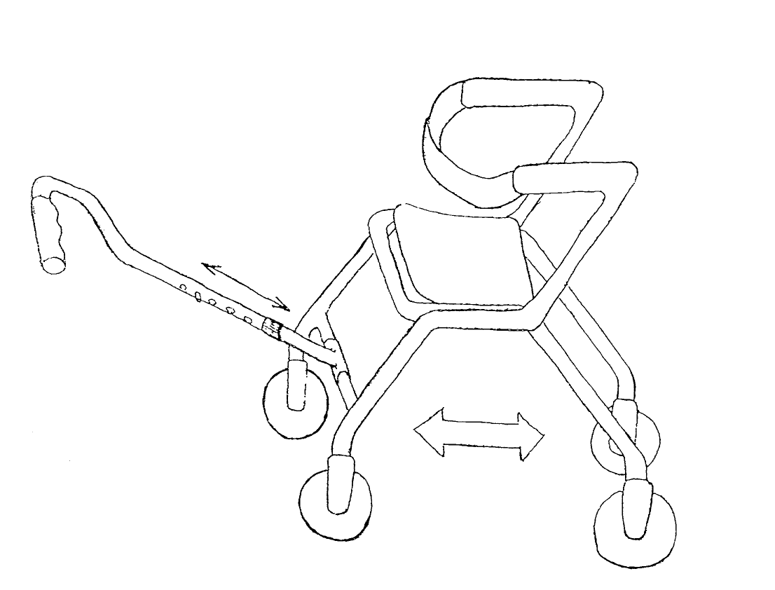

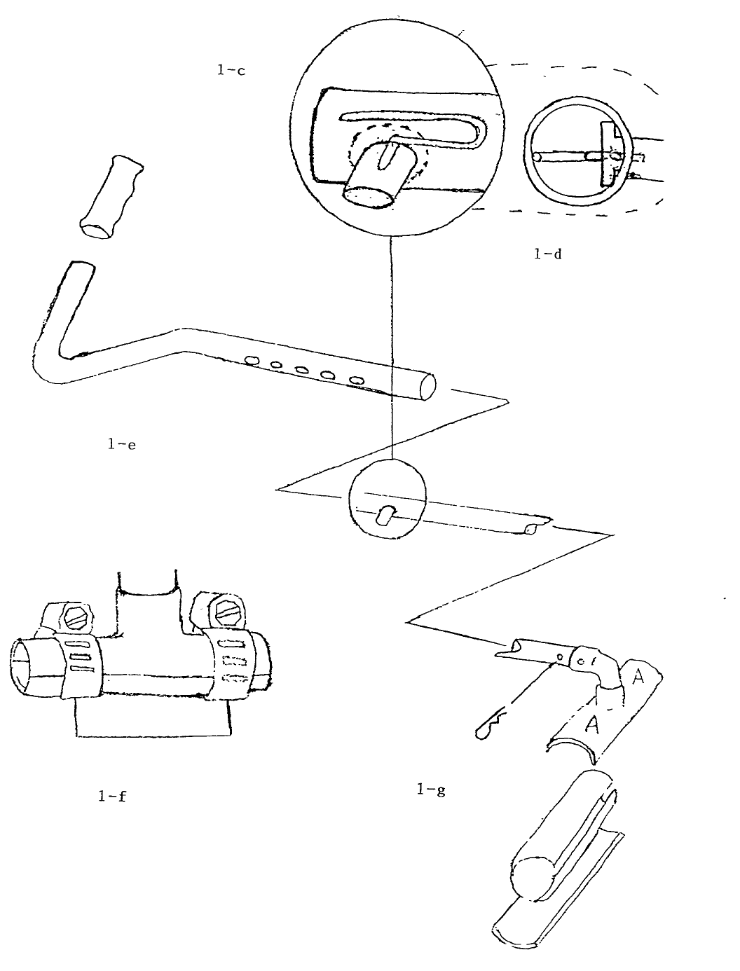

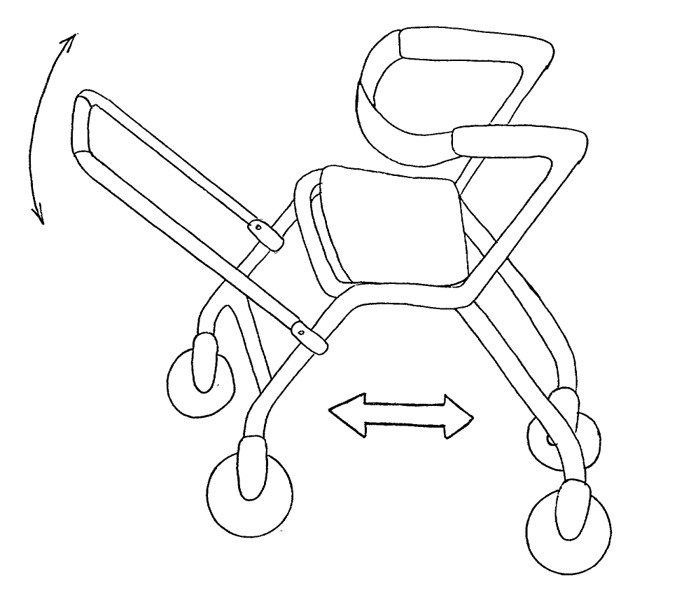

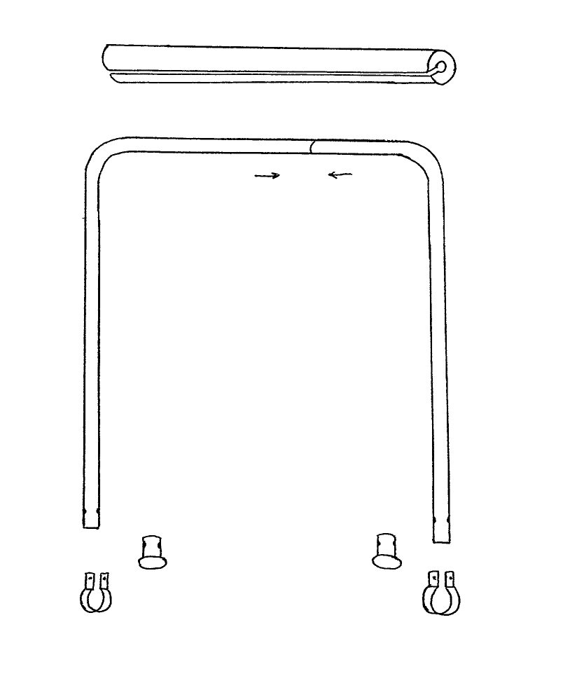

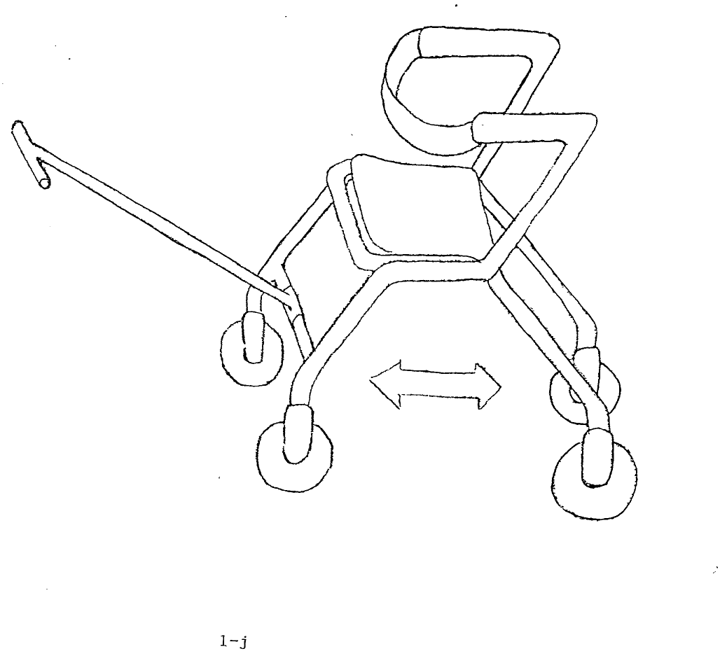

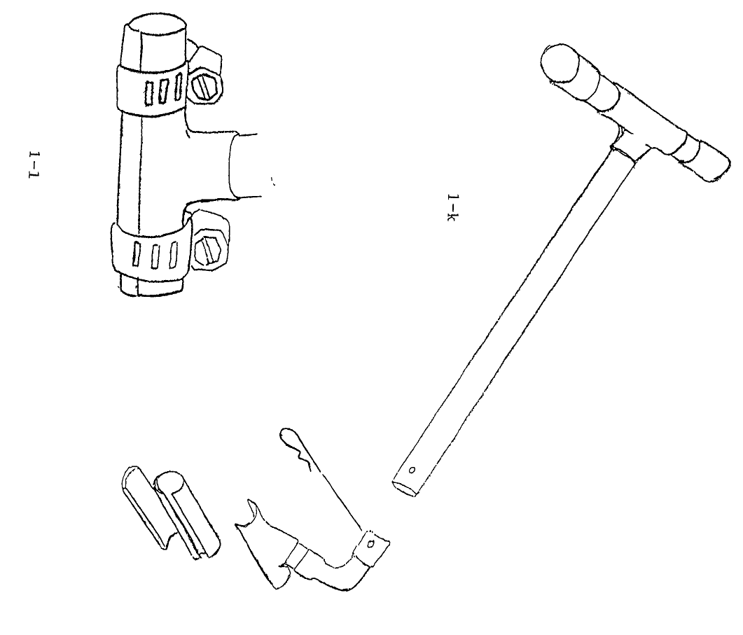

1. A handle bar connectable to a wheeled invalid walker for pulling or pushing a seated invalid, said handle bar comprising:
a bar;
a handle situated at one end of the bar; and
a hinged mount situated at the other end of the bar and connectable to the walker, said handle bar folding toward the walker on the hinged mount into an upright non-operating position.

2. A handle bar as in claim 1 wherein the hinged mount is made of two semi-circular plates surrounding a horizontal tube of the walker structure, said two semicircular plates being hold together by holding clamps, and one of the semi-circular plates being connected with the hinge fixed to the other end of the bar.

3. A handle bar as in claim 1 or 2 wherein the handle bar is adjustable in length.

4. A handle bar as in claim 1 or 2 wherein the handle bar is adjustable in length with a spring actuated button adjuster.

5. A handle bar as in claim 1, 2, 3 or 4 wherein the handle bar is held in the upright position with a holding strap.

6. A handle bar as in one of claims 1-5 wherein the other end of the bar is capped with a protective cap.

7. A handle structure connectable to a wheeled invalid walker for pulling or pushing a seated invalid, said handle comprising:
a U-shape bar having two side sections and a horizontal middle section joining the two side sections, each side section having an end;
a handle formed by the middle section; and
a hinged mount situated at each end of the U-shape bar and connectable to a generally vertically oriented tube of the walker structure, said handle folding toward the walker on the hinged mount into an upright non-operating position.

8. A handle as in claim 7 wherein the U-shape bar is made of two sections allowing distance adjustment between the two side sections

9. A handle as in claim 8 wherein the middle section is covered with a foam grip.

10. A handle bar as in one of claims 7-9 wherein each end of the bar is capped with a protective cap.
